(19) United States
(12) Patent Application Publication
(10) Pub. No.: US 2023/0020812 A1
(43) Pub. Date: Jan. 19, 2023

(54) MODULAR BRUSHLESS DC (BLDC) MOTOR CONSTRUCTION

(71) Applicant: Stoneridge, Inc., Novi, MI (US)

(72) Inventors: Yulanda King, Amherst, NY (US); Jihcheng Lin, Novi, MI (US)

(21) Appl. No.: 17/376,221

(22) Filed: Jul. 15, 2021

(51) Int. Cl. H02K 21/24

(52) U.S. Cl. CPC H02K 21/24; H02K 2213/12

(57) ABSTRACT

A modular DC motor includes a stator module having a stator core. The stator core has a ring-shaped base defining an axis and a plurality of stator posts protruding axially outward from the ring shaped based. A plurality of coils are wound around the stator posts. Each stator post extends axially beyond the corresponding coil. A shaft support is radially inward of the stator ring shaped base and is connected to the ring-shaped base. The shaft support is configured to support a rotor shaft relative to the stator core. The stator module is configured to receive one of a plurality of rotor modules. An operation of the modular DC motor is dependent on the physical configuration of the received one of the plurality of rotor modules. Each rotor module in the plurality of rotor modules has a distinct magnetic configuration from each other rotor module in the plurality of rotor modules.

### TECHNICAL FIELD

The present disclosure relates generally to Brushless DC (BLDC) motor construction, and more specifically to a modular construction using a single stator module for multiple distinct BLDC motor configurations.

### BACKGROUND

Brushless DC (BLDC) Motors are synchronous motors that use a direct current (DC) electric power supply to drive rotation. The motors use an associated electronic closed loop controller to produce several alternating current (AC) signals driven over separate magnetic winding of the motor. The AC signals produce a rotating magnetic flux field. A rotor structure including magnets is positioned within the rotating magnetic flux field, and the interaction between the magnets and the rotating magnetic flux field drives the rotor to rotate.

Due to the myriad of possible uses, BLDC motors are required to have a substantial number of distinct constructions and outputs. The output power and voltage is dependent on the construction of the BLDC motor meaning that each use or implementation of the BLDC motor requires a new construction.

### SUMMARY OF THE INVENTION

In one exemplary embodiment a modular DC motor includes a stator module including a stator core having a ring-shaped base defining an axis and a plurality of stator posts protruding axially outward from the ring shaped based, a plurality of coils, each of said coils being wound around one of said stator posts in the plurality of stator posts, wherein each stator post extends axially beyond the corresponding coil, a shaft support radially inward of the stator ring shaped base and connected to the ring-shaped base, the shaft support configured to support a rotor shaft relative to the stator core, and the stator module being configured to receive one of a plurality of rotor modules, wherein an operation of the modular DC motor is dependent on the physical configuration of the received one of the plurality of rotor modules and wherein each rotor module in the plurality of rotor modules has a distinct magnetic configuration from each other rotor module in the plurality of rotor modules.

In another example of the above described modular DC motor the plurality of rotor modules includes a first set of brushless DC motor (BLDC) rotor module configurations and at least one torque motor rotor module configuration.

In another example of any of the above described modular DC motors the torque motor rotor module configuration includes a first number of permanent magnets per permanent magnet set, the stator module is configured such that the stator posts and coils provide a second number of effective stator poles, and the second number of effective stator poles is the same as the first number of permanent magnets per permanent magnet set.

In another example of any of the above described modular DC motors the first number of rotor poles and the second number of stator posts and coils is either two or six.

In another example of any of the above described modular DC motors a rotor module configuration in the first set of rotor module configurations includes at least one set of magnets in a radial flux position.

In another example of any of the above described modular DC motors the first set of rotor module configurations includes two sets of magnets, each set of magnets being in a corresponding radial flux position, and with each set of magnets having opposing polarities.

In another example of any of the above described modular DC motors the first set of rotor module configurations includes at least one set magnets positioned in an axial flux position.

In another example of any of the above described modular DC motors the first set of rotor module configurations includes at least one set of magnets in a radial flux position.

In another example of any of the above described modular DC motors the first set of rotor module configurations includes two sets of radial flux positioned magnets.

In another example of any of the above described modular DC motors each rotor module configuration in the first set of rotor module configurations has a first number of rotor poles, the stator module has a second number of stator posts and the first number of rotor poles is different than the second number of stator posts.

An exemplary method of assembling a DC motor includes selecting a motor operation from one of a brushless DC (BLDC) motor operation and a torque motor operation, selecting a specific rotor module from a set of distinct rotor modules in a standard stator, the specific rotor module corresponding to the selected motor operation, and installing the selected specific rotor module in the standard stator module, thereby providing a DC motor configured to perform the selected motor operation.

In another example of the above described method of assembling a DC motor the selected motor operation is a torque motor operation, and the specific rotor module includes at least one set of magnets having a number of permanent magnets equal to a number of stator windings in the standard stator module.

In another example of any of the above described method of assembling a DC motor each magnet in the at least one set of magnets is connected to the rotor module such that each magnet is in a radial flux position after the rotor module is installed in the standard stator motor module.

In another example of any of the above described method of assembling a DC motor the selected motor operation is a BLDC motor operation, and the specific rotor module includes at least one set of permanent magnets, wherein all sets of permanent magnets in the at least one set of permanent magnets include a number of magnets different from the number of stator windings in the standard stator module.

In another example of any of the above described method of assembling a DC motor the selected BLDC motor operation is a low voltage radial flux operation and the specific rotor module includes a single set of permanent magnets with the single set of permanent magnets being positioned radially adjacent the stator posts relative to an axis defined by the standard stator module.

In another example of any of the above described method of assembling a DC motor the selected BLDC motor operation is a mid voltage radial flux operation and the specific rotor module includes two sets of permanent magnets with the two set of permanent magnets being positioned radially adjacent the stator posts relative to an axis defined by the standard stator module, with a first of the two sets of permanent magnets being positioned radially inward of the stator posts and a second of the two sets of permanent magnets being positioned radially outward of the stator posts.

In another example of any of the above described method of assembling a DC motor the selected BLDC motor operation is an axial flux operation, and the specific rotor module includes at least one set of permanent magnets positioned at an axial end of a set of stator posts in the standard stator module.

In another example of any of the above described method of assembling a DC motor the selected BLDC motor operation is a combined axial radial flux operation, and selecting the specific rotor module includes selecting a rotor module having a first set of permanent magnets positioned at an axial end of a set of stator posts in the standard stator module and at least one second set of permanent magnets positioned radially adjacent the axial end of the stator.

Another example of any of the above described method of assembling a DC motor further includes changing the selected motor operation by removing a first specific rotor module and inserting a second specific rotor module, the second specific rotor module being distinct from the first specific rotor module.

These and other features of the present invention can be best understood from the following specification and drawings, the following of which is a brief description.

### BRIEF DESCRIPTION OF THE DRAWINGS

FIG. 1 illustrates a high level schematic brushless DC (BLDC) motor having a first rotor module configuration.

FIG. 2A illustrates a cross sectional view of the brushless DC motor of FIG. 1.

FIG. 2B illustrates a cross sectional view of an alternate example of the motor of FIG. 1.

FIG. 3 illustrates a second rotor module configuration for the BLDC motor of FIGS. 1 and 2.

FIG. 4 illustrates a third rotor module configuration for the BLDC motor of FIGS. 1 and 2.

FIG. 5 illustrates a fourth rotor module configuration for the BLDC motor of FIGS. 1 and 2.

FIG. 6 illustrates a fifth rotor module configuration for the BLDC motor of FIGS. 1 and 2.

FIG. 7 illustrates a sixth rotor module configuration for the BLDC motor of FIGS. 1 and 2.

FIG. 8 illustrates an exemplary retention ring for maintaining an axial position of the rotor.

FIG. 9 schematically illustrates a torque motor conversion using the base stator module.

### DETAILED DESCRIPTION

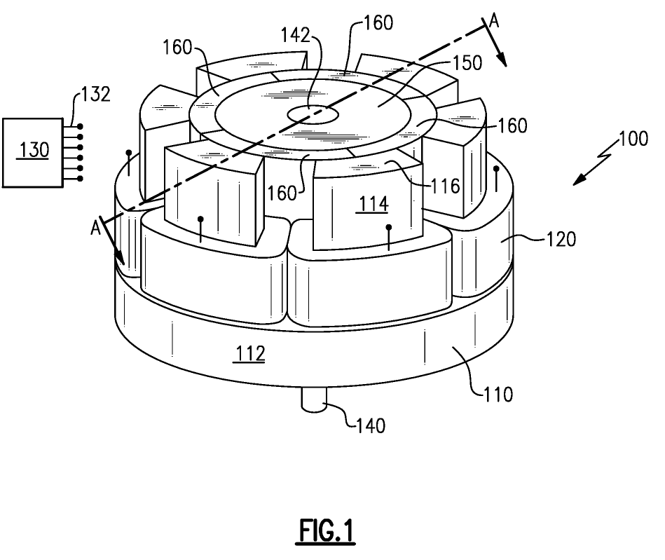

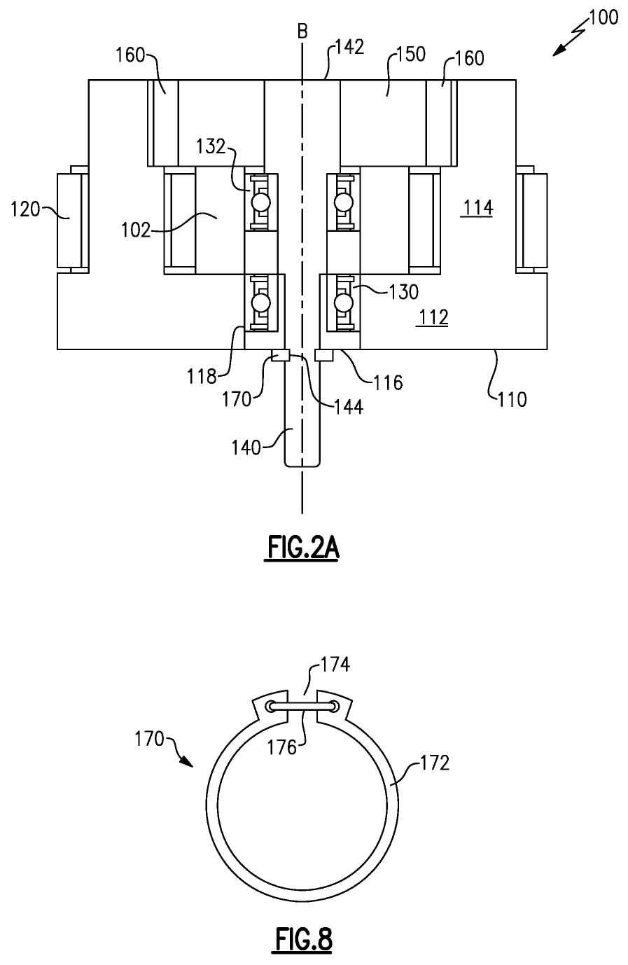

FIG. 1 schematically illustrates a brushless DC motor 100 including a general stator module paired with one of multiple specific rotor modules according to one embodiment. FIG. 2A illustrates a cross sectional view of the brushless DC motor 100 of FIG. 1 along cross sectional line A-A. The general stator module is configured to receive the multiple different specific rotor modules, with the electrical operations of the motor depending on which rotor module in the set of specific rotor modules is paired with the stator module. The brushless DC motor 100 is constructed of a stator core 110 having a ring shaped base 112. Multiple stator posts 114 extend outward from the ring shaped stator base 112. Each of the posts 114 acts as a core for a corresponding coil winding 120. The coil windings 120 are connected to an electric power supply 130 via a corresponding controller connection 132. The controller connection 132 can be configured and controlled in any known configuration for providing AC current to the corresponding coil windings 120 at the correct timing and magnitude, as per conventional motor controls.

The ring shaped base 112 defines an opening 116 including a bushing 117. A pair of bearings 130, 132 are positioned within the bushing 117. The bearings 130, 132 receive a shaft 140, and maintain an axial alignment of the shaft 140 and the stator core 110 while allowing the shaft 140 to rotate freely about the axis B within the bushing 117. The bushing 117 connects to an overmold stator structure 102 within the center of the stator core 110. The combination of the stator core 110, the coil windings 120, the overmold stator structure 102, the bushing 117 and the bearings 130, 132 form a stator module. In alternate examples, such as those illustrated in FIGS. 2B and 3-7, the bearings 130, 132 are omitted and a bushing structure 130' is utilized in place of the bearings. The bushing structure 130' is a cylindrical bushing with an axially aligned ring portion, and is press fit into the stator base 110 and the stator overmold structure 102. The rotor shaft 140 rotates freely within the bushing 130' and is maintained in axial position via the same groove 144 and retention ring 170 structure as described above.

A rotor body 150, alternatively referred to as a rotor disk, is connected to an axial end 142 of the shaft 140, opposite the opening 116 in the stator base 112. The rotor body 150 is a ring, or disc, shape and a set of multiple permanent magnets 160 are connected to a radially outward facing surface 152 of the rotor body 150. The permanent magnets 160 are positioned radially inward of an outer end 116 of the stator posts 114, resulting in a radially aligned (relative to the axis B) flux path from the coil windings 120 into the magnets 160. This configuration is referred to as a radial flux brushless DC motor. The combination of the shaft 140, the rotor disk 150 and the permanent magnets 160 are collectively referred to as a rotor module.

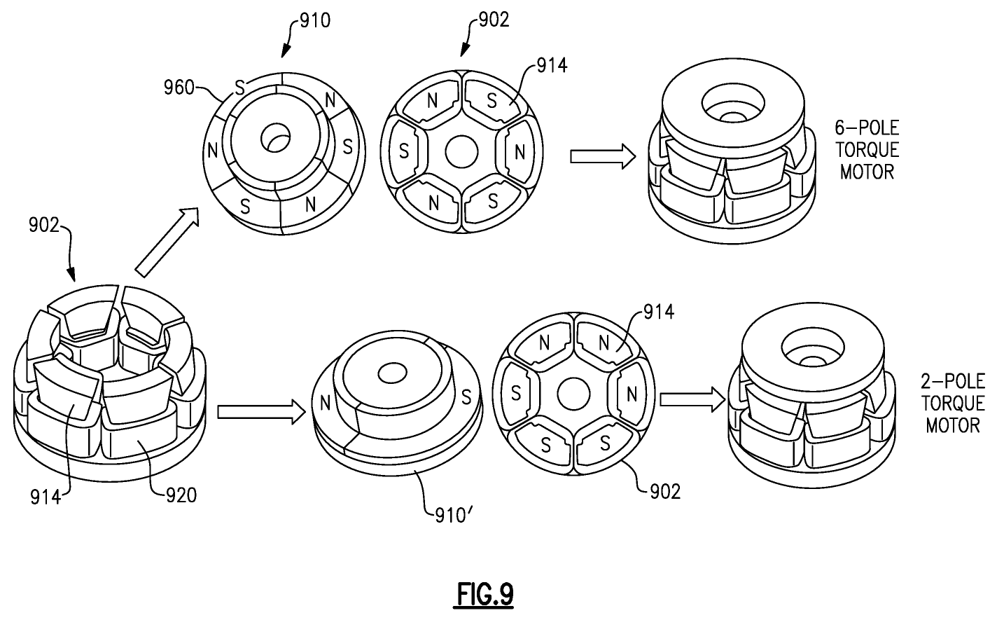

To facilitate installing and/or changing the rotor module, a groove 144 is included on the shaft 140 near an axial end of the shaft 140. The groove 144 is positioned such that, when the rotor module is installed in the stator module, the groove 144 extends just beyond the base of the stator module. A retention ring 170, illustrated in more detail in FIG. 8, is positioned within the groove, and contacts the base of the stator core 110. The retention ring 170 includes an open ring body 172, and a closure 176 capable of closing an opening 174 in the open ring body 172 once the rotor module has been installed in the stator module. Positioning and closing the retention ring 170 locks the rotor module in an axial position and allows the rotor to rotate freely within the stator module. The closure 170 can be removed or opened to change the rotor module.

In the example of FIG. 1, the BLDC motor 100 includes six stator posts 114 and coil winding 120 and four rotor magnets 160. Alternative embodiments can utilize different numbers of stator posts 114, coil windings 120, and rotor magnets 160, with the number of permanent magnets 160 being different from the number of coil windings 120 in a BLDC configuration to achieve distinct torque, distinct speeds, and/or distinct stroke angles. In one alternate example, the number of coil windings 120 is six, and the number of rotor magnets 160 is eight. The different number of magnets 160 ensures that the switching operations of the coil windings causes a continuous rotation of the rotor.

Some industrial and commercial applications utilize brushless motors in multiple products, or in multiple implementations within a single product. In such cases, the different applications require many different BLDC configurations to generate different torque and/or power outputs. Conventional systems design a distinct BLDC construction for each application and for each design. This approach can lead to a costly design process requiring different design constraints and packaging for each different BLDC application.

In order to minimize costs, as well as design time, the modular BLDC structure described herein utilizes a standard stator module configured to receive a number of different rotor constructions, with each different rotor module construction defining the power characteristics (i.e. the electrical operations) of the BLDC. In some specific examples, the configuration of the rotor module can convert the standard BLDC stator module to a torque motor module. The use of a single standard stator module allows at least a portion of the packaging and structural elements such as housing and connections to be uniform across multiple applications, as well as allowing for economies of scale to reduce the overall cost of the BLDC’s due to the standard stator module used in all variations.

With continued reference to FIG. 1, FIGS. 3-7 illustrate distinct rotor modules 300-700, each of which is received in, and operates with, the single standard stator module 110 illustrated in FIGS. 1 and 2.

In FIG. 3, the rotor module 300 includes the shaft 340, and a disk 350 on which a single set of permanent magnets 360 are mounted. The disk 350 extends axially beyond, and covers, an axial end of each of the stator posts 314. A portion 351 of the disk 350 extends axially toward the stator base 312 from a radially outward edge of the disk 350. Permanent magnets 360 are mounted on a radially inward facing surface 352 of the portion 351. The permanent magnets 360 create a radially aligned flux flowpath from the coil windings on the stator posts 314 to the magnets 360. When paired with the general stator module described with regards to FIG. 1, the rotor configuration of FIG. 3 creates a relatively low torque/power output radial flux BLDC motor. As used herein “relatively low” refers to approximately 9 V-16 V operations.

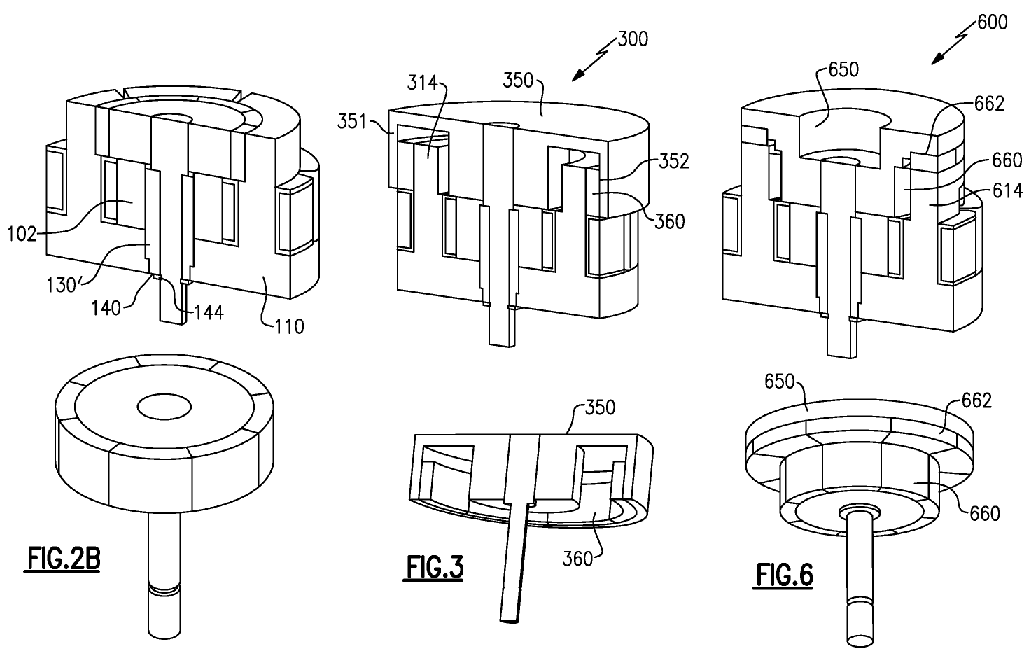

In FIG. 4, the rotor module 400 is generally similar to that of FIG. 3, including the rotor disk 450 that extends axially beyond, and covers, an axial end of the stator posts 414 with a radially inward extending portion 451 at a radially outward edge of the disk 350. The first set of permanent magnets 460 are positioned on a radially inward facing surface of the radially inward extending portion 451 in the same manner as the rotor module 300 of FIG. 3. In addition to the first set of permanent magnets 460, the rotor module 400 of FIG. 4 includes a second set of permanent magnets 462. The second set of permanent magnets 462 are positioned radially outward of the axial end of the stator posts 414. The second set of permanent magnets 462 creates an axial flux path with the coil windings 420. When the rotor module 400 of FIG. 4 is paired with the general stator module described with regards to FIG. 1, and illustrated again in FIG. 4, the rotor configuration of FIG. 4 provides a mid level torque/power output hybrid axial -radial flux BLDC motor. As used herein mid-level refers to a 16 V-28 V range.

FIG. 5 schematically illustrates a cross section of a rotor module 500 for providing a mid level torque/power output radial flux BLDC motor. The rotor disk 550 uses the same configuration as the disk 350 of FIG. 5, with the addition of a support portion 502 extending radially outwards from the shaft 540 and supporting a second set of permanent magnets 564. The second set of permanent magnets 564 is radially inward of the stator post 514 and provides a second radially aligned flux path with the corresponding coil windings 520. Each radially inward permanent magnet 564 has a corresponding radially outward permanent magnet 564 that is directly across from the radially inward permanent magnet 564. Each pair of corresponding magnets has an opposite north/south polarity. This configuration is referred to herein as each set of magnets having opposing polarities. By using two sets of permanent magnets 560, 564, the rotor module 500 of FIG. 5 generates approximately twice the power/torque output when paired with the stator module as the stator module paired with the rotor module 300 of FIG. 3, with the variations being due to tolerances and efficiency differences.

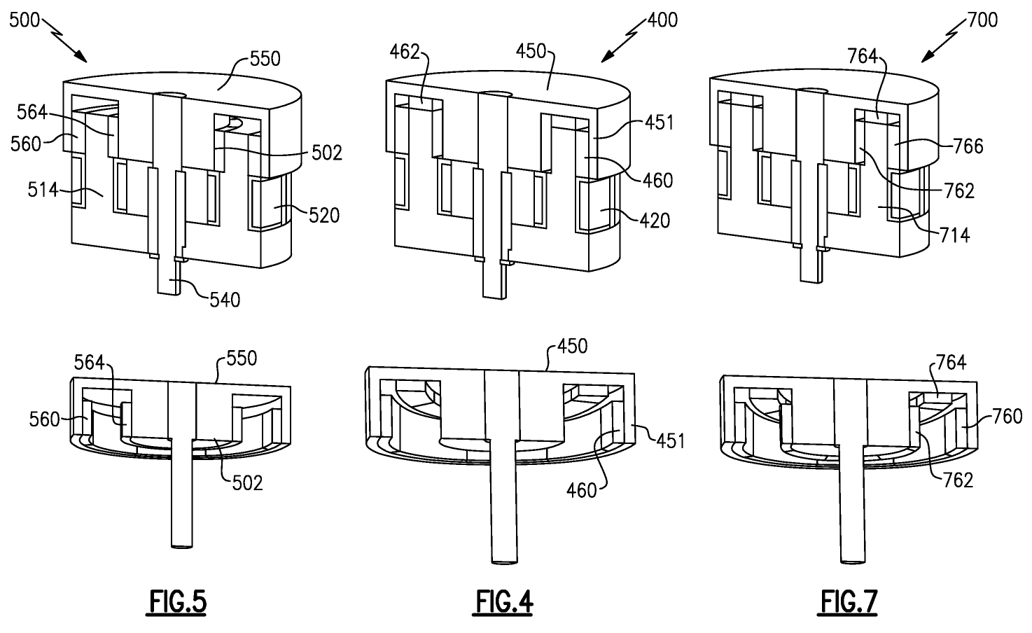

FIG. 6 illustrates an alternate configuration for a rotor module 600 that provides similar power/torque output capabilities as the rotor module 400 of FIG. 4. The rotor disk 650 omits the axially extending portion at the circumferential edge of the rotor disk 650, as no permanent magnets are placed at the radially outward edge of the stator posts 614. In alternate examples, such as where a uniform packaging is desired for all the rotor module configurations, the axially extending portion can be added without positioning or attaching permanent magnets to the inward extending portion. The alternate configuration of FIG. 6 provides a first set of permanent magnets 660 on a radially inward side of the stator posts 614, and a second set of permanent magnets 662 at an axial end of the stator post 614.

FIG. 7 illustrates another rotor module 700 configured to provide a first set of permanent magnets 760 radially outward of the stator post 714, a second set of permanent magnets 762 radially inward of the stator post 714 and a third set of permanent magnets 764 positioned at an axial end of the stator post 714. The physical structure of FIG. 7 is approximately identical to the structure of the rotor module 500 of FIG. 5, with the addition of the third set of permanent magnets 764. The rotor module 700 of FIG. 7 provides a hybrid radial-axial flux BLDC motor when paired with the standard stator module illustrated in all the Figures.

The multiple various rotors provide distinct output torques and/or output powers from the single general stator module (FIGS. 1 and 2). Further enhancing the variability of the modular construction described here is the availability of distinct voltage inputs (e.g. 12 V, 24 V, and 48 V inputs), with the higher the voltage input corresponding to a higher torque and/or output power and a larger number of sets of permanent magnets resulting in a higher torque and/or output power. By way of example, a 12 V input provided to the example of FIG. 3 (having a single set of permanent magnets) will provide approximately ⅓ the torque and/or power output of the same 12 V input provided to the example of FIG. 7 (having three sets of permanent magnets). In this way the base BLDC stator can be transformed through multiple distinct output torque and/or power configurations by changing the rotor module and adjusting the input power to match the requirements of a given application. This, in turn, reduces design and manufacturing cotss by decreasing the number of unique components, and providing a uniform packaging size and shape for the BLDC motor.

With continued reference to all of the rotor modules of FIGS. 1-7, the illustrated examples include a number of permanent magnets in each set of permanent magnets that is different than the number of stator poles. In some examples, the number of magnets can be larger than the number stator posts, and in other examples, the number of permanent magnets in each set is less then the number of stator posts. The different number of permanent magnets and stator posts allows the combined rotor module and stator to be operated as a brushless DC motor providing a smooth, continuous, rotational output.

In another example, the BLDC stator module can be converted to a torque motor by changing the number of permanent magnets 960 in each set of permanent magnets 960 in the rotor module to match the number of effective stator poles in the stator module 902. FIG. 9 schematically illustrates two example rotor modules 910, 910' with the shafts omitted for clarity that achieve this conversion. The first rotor module, 910 includes sets of permanent magnets 960 in an alternating north/south (n/s) configuration, with the same number of magnets 960 as stator posts 914 and coil windings 920. During operation, the coil windings 920 are switched between north and south alignments, and each switch causes the rotor to rotate so that the magnets 960 are aligned with a stator post 914 having the same magnetic alignment. In the first example, the stator module 902 alternates the alignment of each coil winding 920 resulting in a number of poles during operation that matches the number of coil windings 920 and stator posts 914. This configuration is a 6-pole torque motor.

In the second example the rotor module 910' uses only two permanent magnets, one with a north orientation and one with a south orientation. In order to operate with the same number of effective stator poles, the stator module 902 operates three consecutive coil windings 914 in a north polarity, and the next three consecutive windings in a south polarity. By switching the windings back and forth in this configuration, the stator module operates as a two-pole module, despite the physical presence of six stator posts 914 and windings. The different switching configurations can be adjusted purely using the controller controlling the switch, according to known controller techniques, and no physical reconfiguration of the stator module 902 is required. This configuration is a 2-pole torque motor.

Matching the number of permanent magnets in each set to the number of effective stator poles allows the power controller 130 to generate precise rotations of the shaft equal to 360 degrees divided by the number of stator poles. By way of example, the first configuration 902, 910 includes six stator posts 114, and operation as a torque motor will allow discrete rotational steps of 60 degrees. As can be appreciated, increasing the number of effective stator poles (e.g. the number of coil windings and permanent magnets) decreases the output torque that can be provided in each step for a given input voltage and/or power. Each of the rotor module configurations described above with regards to FIGS. 1-7 can be utilized to create the torque motor configuration, instead of the BLDC motor configuration, by using a number of magnets in each set of permanent magnets that is equal to the number of stator posts. When such a rotor is used, conventional torque motor controls are applied to the stator coil windings, instead of BLDC motor controls, and the motor is operated in that manner.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

1. A modular DC motor comprising:
a stator module including a stator core having a ring-shaped base defining an axis and a plurality of stator posts protruding axially outward from the ring shaped based;
a plurality of coils, each of said coils being wound around one of said stator posts in the plurality of stator posts, wherein each stator post extends axially beyond the corresponding coil;
a shaft support radially inward of the stator ring shaped base and connected to the ring-shaped base, the shaft support configured to support a rotor shaft relative to the stator core; and
the stator module being configured to receive one of a plurality of rotor modules, wherein an operation of the modular DC motor is dependent on the physical configuration of the received one of the plurality of rotor modules and wherein each rotor module in the plurality of rotor modules has a distinct magnetic configuration from each other rotor module in the plurality of rotor modules.

2. The modular DC motor of claim 1, wherein the plurality of rotor modules includes a first set of brushless DC motor (BLDC) rotor module configurations and at least one torque motor rotor module configuration.

3. The modular DC motor of claim 2, wherein the torque motor rotor module configuration includes a first number of permanent magnets per permanent magnet set, the stator module is configured such that the stator posts and coils provide a second number of effective stator poles, and the second number of effective stator poles is the same as the first number of permanent magnets per permanent magnet set.

4. The modular DC motor of claim 3, wherein the first number of rotor poles and the second number of stator posts and coils is either two or six.

5. The modular DC motor of claim 2, wherein a rotor module configuration in the first set of rotor module configurations includes at least one set of magnets in a radial flux position.

6. The modular DC motor of claim 5, wherein the first set of rotor module configurations includes two sets of magnets, each set of magnets being in a corresponding radial flux position, and with each set of magnets having opposing polarities.

7. The modular DC motor of claim 2, wherein the first set of rotor module configurations includes at least one set magnets positioned in an axial flux position.

8. The modular DC motor of claim 7, wherein the first set of rotor module configurations includes at least one set of magnets in a radial flux position.

9. The modular DC motor of claim 8, wherein the first set of rotor module configurations includes two sets of radial flux positioned magnets.

10. The modular DC motor of claim 2, wherein each rotor module configuration in the first set of rotor module configurations has a first number of rotor poles, the stator module has a second number of stator posts and the first number of rotor poles is different than the second number of stator posts.

11. A method of assembling a DC motor comprising:
selecting a motor operation from one of a brushless DC (BLDC) motor operation and a torque motor operation;
selecting a specific rotor module from a set of distinct rotor modules in a standard stator, the specific rotor module corresponding to the selected motor operation; and
installing the selected specific rotor module in the standard stator module, thereby providing a DC motor configured to perform the selected motor operation.

12. The method of claim 11, wherein the selected motor operation is a torque motor operation, and the specific rotor module includes at least one set of magnets having a number of permanent magnets equal to a number of stator windings in the standard stator module.

13. The method of claim 12, wherein each magnet in the at least one set of magnets is connected to the rotor module such that each magnet is in a radial flux position after the rotor module is installed in the standard stator motor module.

14. The method of claim 11, wherein the selected motor operation is a BLDC motor operation, and the specific rotor module includes at least one set of permanent magnets, wherein all sets of permanent magnets in the at least one set of permanent magnets include a number of magnets different from the number of stator windings in the standard stator module.

15. The method of claim 14, wherein the selected BLDC motor operation is a low voltage radial flux operation and the specific rotor module includes a single set of permanent magnets with the single set of permanent magnets being positioned radially adjacent the stator posts relative to an axis defined by the standard stator module.

16. The method of claim 14, wherein the selected BLDC motor operation is a mid voltage radial flux operation and the specific rotor module includes two sets of permanent magnets with the two set of permanent magnets being positioned radially adjacent the stator posts relative to an axis defined by the standard stator module, with a first of the two sets of permanent magnets being positioned radially inward of the stator posts and a second of the two sets of permanent magnets being positioned radially outward of the stator posts.

17. The method of claim 11, wherein the selected BLDC motor operation is an axial flux operation, and the specific rotor module includes at least one set of permanent magnets positioned at an axial end of a set of stator posts in the standard stator module.

18. The method of claim 11, wherein the selected BLDC motor operation is a combined axial radial flux operation, and selecting the specific rotor module includes selecting a rotor module having a first set of permanent magnets positioned at an axial end of a set of stator posts in the standard stator module and at least one second set of permanent magnets positioned radially adjacent the axial end of the stator.

19. The method of claim 11, further comprising changing the selected motor operation by removing a first specific rotor module and inserting a second specific rotor module, the second specific rotor module being distinct from the first specific rotor module.
